(19) United States
(12) Patent Application Publication
(10) Pub. No.: US 2009/0188269 A1
(43) Pub. Date: Jul. 30, 2009

(54) HIGH PRESSURE CONNECTION SYSTEMS AND METHODS FOR THEIR MANUFACTURE

(75) Inventors: Shabbir Attarwala, Simsbury, CT (US); Prakash S. Patel, Algonquin, IL (US)

Correspondence Address: LOCTITE CORPORATION, 1001 TROUT BROOK CROSSING, ROCKY HILL, CT, 06067, US

(73) Assignee: Henkel Corporation, Rocky Hill, CT (US)

(21) Appl. No.: 12/358,798

(22) Filed: Jan. 23, 2009

Related U.S. Application Data
(60) Provisional application No. 61/023,568, filed on Jan. 25, 2008.
(60) Provisional application No. 61/028,395, filed on Feb. 13, 2008.

(51) Int. Cl. F25D 23/00; B23P 19/04

(52) U.S. Cl. 62/259.1; 29/700

(57) ABSTRACT

A high pressure connection and method for making a high pressure connection. The method includes applying a primer composition to one distal joint portion, applying an anaerobically curable composition to the other distal joint portion; sliding one distal joint portion into the other distal joint portion and curing the anaerobic composition to maintain the second distal joint portion within the first distal joint portion thereby forming the high pressure connection. The method does not use plastic deformation of the first or second distal joint portions after the step of sliding. The method is advantageously useful for making high pressure connections in gas compression or refrigeration systems.

### FIELD

The present disclosure relates generally to new and improved high pressure connection systems and methods for their manufacture. In advantageous aspects the present disclosure relates to new and improved two part, high pressure connection systems and methods for their manufacture that can be used in gas compression systems and refrigeration systems.

### BRIEF DESCRIPTION OF RELATED TECHNOLOGY

Refrigeration systems that rely on a refrigerant phase change to provide a temperature differential are used in numerous applications including commercial and residential refrigeration, freezing, air conditioning and heating systems. Refrigeration systems typically include a compressor, a condenser, a metering device and an evaporator all fluidly connected and containing a refrigerant. The compressor takes low pressure refrigerant vapor and pressurizes the vapor. Refrigeration compressors can be of the reciprocating piston, screw, rotary, scroll or centrifugal type. The condenser takes high pressure refrigerant vapor from the compressor, removes heat from this vapor and condenses the vapor to a pressurized liquid. The metering device modulates or restricts flow of the liquid refrigerant to the evaporator. Metering devices range from a capillary tube as used in residential refrigerators to a modulating thermostatic expansion valve used in more sophisticated systems. The evaporator allows liquid refrigerant to absorb heat and evaporate to a gas. The refrigeration system can also include accessories such as refrigerant dryers, system access points to check internal pressure and add refrigerant, etc.

The refrigerant is a material that can change between liquid and vapor phases under specified conditions. Refrigerants include the fluorinated hydrocarbon refrigerants such as R-20 (CHCl₃), R-22 (CHF₂CL), R-22B1 (CHBrF₂), R-32 (CH₂F₂), R-125 (CHF₂CF₃), R-134A (CH₂FCF₃), R-143A (CH₃CF₃), R-152A (CH₃CHF₂), R-404A (a zeotropic mixture of R-125 and R-143A), R-407C (a zeotropic mixture of R-32, R-125 and R-134A), R-410A (a zeotropic mixture of R-32 and R-125), R-502 (an azeotropic mixture of R-22 and R-115), R-507 (an azeotropic mixture of R-125 and R-143A), R-1120 (CHClCCl₂) and R—C316 (C₄Cl₂F₆). Refrigerants also include non-fluorinated refrigerants such as ammonia (NH3), R-290 (propane), R-600 (butane) and R-600A (isobutene).

Many high pressure connections exist between and among the compressor, condenser, metering device, evaporator and accessories. To be commercially acceptable for use in a refrigeration system each connection has several properties. For instance, the connections are to contain the refrigerant and any refrigerant oil for the life of the system. The connections are to withstand the internal working pressure of compressed and liquid refrigerant pressures without failure. Earlier refrigeration systems had working pressures of about 200 pounds per square inch. However, different refrigerants have come into use in recent times to meet evolving environmental standards and high pressure connections in these new refrigeration systems need to be designed with those environmental standards in mind. The connections are to withstand flexing and vibration without fracture or failure. The connections are to be inert to internal environmental conditions such as exposure to refrigerant or refrigerant oil. A connection material that washes off or dissolves during use can undesirably redeposit in or on other parts of the refrigeration system leading to compromises in the integrity if the refrigeration system causing inefficiencies in operation, aesthetic problems and even failures. The connections are to be resistant to external environmental conditions such as exposure to floor cleaning chemicals. The connections are to be useful with refrigeration system components and tubing of different sizes and materials. The connections are to be useful with refrigeration system components having large gaps, for example 0.01 inches to 0.05 inches, between the assembled components. The connections are to be fabricated quickly. Some assembly operations are used to connection formation times of less than ten seconds. After assembly the connections are to be capable of use quickly. Some assembly operations pressurize and start the refrigeration system less than one hour after the connections are made. The connections are desirably made by workers with minimal training using inexpensive equipment. It is desirable that the connections can be fabricated without using hazardous materials or hazardous processes. Naturally it is desirable that the connection can be fabricated at a low cost. The connections should also be repairable without special equipment.

Typically, smaller refrigeration systems use two processes to form high pressure connections: high temperature fusion joining processes such as welding or brazing and low temperature mechanical joining processes that rely on swaging or plastic deformation of the joined components. However, despite a long period of use neither of these processes is completely satisfactory for a high pressure connection. High temperature processes require expensive automated equipment or skilled workers. High temperature processes require use of hazardous or flammable fluxes. Only selected brazing filler materials are useful in refrigeration system connections. Brazing can not be used in a high pressure connection having an aluminum member. The high temperatures and open flames used in fusion joining processes are dangerous when flammable refrigerants are present. Low temperature swaging processes such as the LOKRING process permanently deform the attached parts. This prevents disassembly of the joined parts and makes subsequent repair of a damaged connection difficult. Swaging processes also add expensive components to the connection and require use of expensive equipment. The swaging components must be selected based on connection diameter, thereby requiring a user to maintain a plurality of connectors for each connection member size or limit the connection sizes used. Workers must be trained to correctly use the swaging equipment and swaging process. Even with training, swaging of parts having large gaps or swaging of small diameter parts is difficult at best. It is not usually possible to form a swaged connection during a field repair.

U.S. Pat. No. 3,687,019 discloses a two part tube joint construction for a hermetic compressor. This tube joint construction relies on an interference fit between parts, uses a mechanical crimp between the parts and an anaerobic sealant. Even with an interference fit between parts, a mechanical crimp and anaerobic sealant the tube joint construction appears to be limited to an internal pressure of only up to 500 pounds per square inch.

U.S. Pat. No. 3,785,025 also discloses a two part tube joint construction for a hermetic compressor. This tube joint construction relies on an interference fit between parts, uses a mechanical crimp between the parts and an anaerobic sealant and suffers from the same internal pressure deficiencies as those in the '019 patent.

U.S. Pat. No. 6,494,501 discloses a multiple part joint construction including a double wall pipe connector. This pipe connector requires two spaced walls defining a gap between which a tube and sealant is disposed. Such a connector is difficult to form, limited to use with only one tube diameter and adds an additional part and operation to the formation of a tubing connection.

Despite the state of the technology, there remains a need for a new type of high pressure connection useful in compressed gas and refrigeration systems.

### SUMMARY

The present application provides broadly a method of making a connection capable of withstanding pressure using a radically curable composition.

One aspect thereof in a more specific embodiment provides a method of making a high pressure connection. As used herein a high pressure connection is a connection that can retain gas or liquid at a pressure of at least 1200 pounds per square inch. The high pressure connection is advantageously useful in compressed gas systems and refrigeration systems. The high pressure connection consists essentially of a first distal joint portion, a second distal joint portion and a cured composition therebetween. As used herein a “high pressure connection consisting essentially of a first distal joint portion, a second distal joint portion and a cured composition therebetween” indicates that high pressure connections incorporating other structural elements are not included. Thus, high pressure connections that require other structural elements to form a high pressure connection, for example, weld material, threads, a ferrule, a driver ring, a lock ring, a swage ring or plastic deformation of the tubular structures are disclaimed in this aspect.

The method of this embodiment comprises providing the first distal joint portion. The first distal joint portion includes a substantially uniform cylindrical outer surface free from threads, a substantially uniform cylindrical inner surface free from threads having an inner diameter defining a bore through the member, and a circumferential end connecting the outer and inner surfaces.

The second distal joint portion is also provided. The second distal joint portion includes a substantially uniform cylindrical outer surface free from threads and defining an outer diameter smaller than the first distal joint portion inner diameter, a substantially uniform cylindrical inner surface free from threads defining a bore through the member, and a circumferential end connecting the outer and inner surfaces.

A primer composition is applied to one of the distal joint portions.

A radically curable composition is applied to the other of the distal joint portions.

The second distal joint portion is slidingly received into the first distal joint portion.

In some variations either or both of the primer composition and curable composition are applied to the distal joint portions after the second distal joint portion is slidingly received into the first distal joint portion. Typically the primer composition and/or curable composition would be applied adjacent the exposed distal joint region and would flow or wick between the adjacent distal joint portions.

The radically curable composition may be anaerobically cured to maintain the second distal joint portion within the first distal joint portion thereby forming the high pressure connection. There is no plastic deformation of the material comprising the first distal joint portion or the second distal joint portion after the step of sliding. Plastic deformation refers to a permanent change in the shape of an object caused by an applied force.

The method can be used to retain gasses or liquid refrigerant at a pressure greater than 1200 pounds per square inch, advantageously at a pressure greater than 1500 pounds per square inch and more advantageously at a pressure greater than 2000 pounds per square inch within the system.

The method can be used when the first and second distal joint portions are independently selected from copper, aluminum, steel, coated steel and plastic. The method is advantageous when one distal joint portion is aluminum and the other distal joint portion is independently selected from copper, aluminum, steel, coated steel and plastic.

The method can be used when there is a gap up to about 0.05 inches between the first distal joint portion inner diameter and the second distal joint portion outer diameter.

In some embodiments the high pressure connection is a two part connection. As used herein a two part tube connection includes only the two tubes or members to be joined. Each tube includes one distal joint portion so that the distal joint portion of one tube is disposed within the distal joint portion of the other tube. A two part tube connection does not use fittings or connectors to join the two tubes.

In some embodiments the high pressure connection may be a multiple part connection. As used herein a multiple part tube connection includes the two tubes or members to be joined and further includes an additional short fitting or short connector. Each tube includes one distal joint portion and the connector includes two distal joint portions. The distal joint portion of each tube is slidingly received within the respective distal joint portions of the connector. Typically in multiple part connections the tubes are in end to end relationship and are not disposed within each other.

In some embodiments the high pressure connection is advantageously used in a refrigerator, a freezer, a refrigerator-freezer, an air conditioner, a heat pump, a residential heating, ventilation and air conditioning (“HVAC”) system, a commercial HVAC system or a transportation HVAC system such as in an automobile, truck, train, airplane, boat, etc.

In some embodiments the high pressure connection is advantageously used in a gas compression system such as an air compressor system.

The curable composition advantageously comprises a (meth)acrylate component. The curable composition may optionally comprise a monofunctional (meth)acrylate. The curable composition advantageously uses a free radical cure mechanism and more advantageously uses an anaerobic cure mechanism and an anaerobic cure-inducing component.

The primer composition includes an activator. In some embodiments the primer composition includes a reactive carrier, a polymeric matrix or both.

In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in earlier materials and processes or that are otherwise not necessary to the achievement of the function and/or objective of the present disclosure.

When the word “about” is used herein it is meant that the amount or condition it modifies can vary some beyond the stated amount so long as the function and/or objective of the disclosure are realized. The skilled artisan understands that there is seldom time to fully explore the extent of any area and expects that the disclosed result might extend, at least somewhat, beyond one or more of the disclosed limits. Later, having the benefit of this disclosure application and understanding the embodiments disclosed herein, a person of ordinary skill can, without inventive effort, explore beyond the disclosed limits and, when embodiments are found to be without any unexpected characteristics, those embodiments are within the meaning of the term “about” as used herein.

### BRIEF DESCRIPTION OF THE DRAWINGS

Referring now to the drawings wherein like elements are numbered alike in the several Figures;

FIG. 1 is a schematic representation of a refrigeration system.

FIG. 2 is an exploded, schematic elevational view of portions of two tubular members forming a two part connection.

FIG. 3 is an exploded, schematic, elevational view of portions of two tubular members forming a multiple part connection.

FIG. 4 is a perspective view of a two part, high pressure connection comprising an aluminum member and a copper member.

FIG. 5 is a perspective view of a portion of a refrigerator. The arrows illustrate two part, high pressure connections formed according to the method of this disclosure

### DETAILED DESCRIPTION

A fluid connection and method useful to prepare the fluid connection is provided. The fluid connection can advantageously be a high pressure connection. The high pressure connection is useful for a number of applications. However, refrigeration system connections have unique and stringent requirements not all of which are necessary in other types of fluid connections. The disclosed high pressure connection is advantageously useful in preparing a connection in a refrigeration system impermeable to refrigerants and refrigerant oils. For clarity refrigeration systems are described herein, however as noted refrigeration systems are not the only systems that may benefit from the advantages of the subject application.

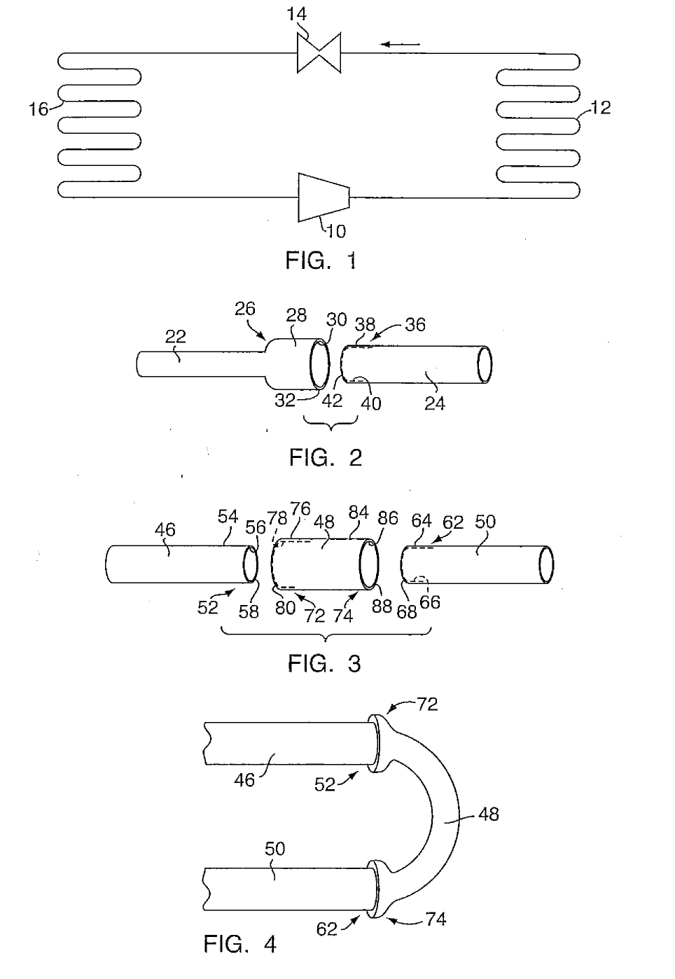

With reference to FIG. 1, refrigeration systems include a compressor 10, a condenser 12, a metering device 14 and an evaporator 16 all fluidly connected and containing a refrigerant. There are a plurality of high pressure connections (not shown for clarity) between, and within, the compressor, condenser, metering device, evaporator and any accessories. The connections are preferably two part connections as shown in FIG. 2 although multiple part connections as shown in FIG. 3 are known in refrigeration systems. Each two part connection typically comprises two hollow, tubular members 22, 24.

Each tubular hollow member is independently comprised of a material, for example copper, aluminum, steel, coated steel and plastic. Coated steel includes a steel member coated with another material, for example a steel member coated with copper plating. In one embodiment one tubular connector is comprised of aluminum and the other tubular connector is comprised of copper. In one embodiment both tubular connectors are comprised of aluminum. In one embodiment at least one of the tubular members is plastic.

Each tubular member typically has a length many times, for example five to ten times or more, its diameter. One tubular member 22 has a distal joint portion 26 including a substantially uniform cylindrical outer surface 28 free from threads, a substantially uniform cylindrical inner mating surface 30 free from threads having an inner diameter and a circumferential end 32 connecting the outer 28 and inner 30 surfaces. The inner diameter does not include any optional chamfer or expansion of the distal joint portion 26 adjacent the end 32. The other tubular member 24 has a distal joint portion 36 including a substantially uniform cylindrical outer mating surface 38 free from threads and defining an outer diameter, a substantially uniform cylindrical inner surface 40 free from threads and a circumferential end 42 connecting the outer 38 and inner 40 surfaces. The outer diameter does not include any optional chamfer or expansion of the distal joint portion 36 adjacent the end 42. The inner diameter of distal joint portion 26 is larger than the outer diameter of distal joint portion 36 to allow distal joint portion 36 to be disposed within distal joint portion 26. Since the members 22, 24 are generally formed without machining, e.g. from purchased tubing or swaged tubing, each member can have a considerable range of distal joint portion diameters. Given this range of diameters the gap between a complementary set of members 22, 24 can be in the range of about 0.001 inches to about 0.05 inches. No interference or press fit between the inner diameter of distal joint portion 26 and the outer diameter of distal joint portion 36 is required to form a high pressure connection.

Surprisingly, it has been found that a leakproof connection can be achieved that can maintain integrity at pressures of about 1200 pounds per square inch or more between non-threaded complementary members having gaps up to 0.05 inches if the anaerobically curable composition is used in combination with a preselected primer composition.

To prepare a high pressure connection complementary members 22, 24 are provided. The mating surfaces 30, 38 should be clean and free of contamination. Abrasion of one or both mating surfaces may be advantageous. A primer composition is applied to the mating surface 30, 38 of one distal joint portion 26, 36 respectively. A curable composition is applied to the mating surface of the other of the distal joint portion. The smaller diameter distal joint portion 36 is slidingly disposed within the larger diameter distal joint portion 26. Some rotation of the distal joint portions may be beneficial to distribute the primer composition and curable composition around the entirety of the mating surfaces but is not required. The members 22, 24 are held in position for less than about 30 seconds, advantageously less than about 15 seconds and desirably less than about 10 seconds to allow the curable composition to maintain the second tubular member distal joint portion within the first tubular member distal joint portion. The composition is cured for a short time thereby forming the high pressure connection between the ends 32, 42 of the distal joint portions. Typical cure times will be less than 60 minutes and advantageously less than 30 minutes before the connection can be pressurized for use. The high pressure connection will maintain pressure greater than about 1200 pounds per square inch and advantageously greater than about 1500 pounds per square inch and more advantageously greater than about 2000 pounds per square inch after fully curing.

The exterior surface 28 of distal joint portion 26 defines an exterior surface of the high pressure connection and the interior surface 40 of distal joint portion 36 defines an interior surface of the high pressure connection. Plastic deformation in the material of either distal joint portion 26, 36 after disposition of the smaller diameter distal joint portion 36 within the larger diameter distal joint portion 26 is advantageously avoided.

In another embodiment a multiple part connection typically comprises two hollow, tubular members 46, 50 and a hollow connector 48. One tubular member 46 has a distal joint portion 52 including a substantially uniform cylindrical outer surface 54 free from threads, a substantially uniform cylindrical inner surface 56 free from threads having an inner diameter and a circumferential end 58 connecting the outer 54 and inner 56 surfaces. The other tubular member 50 has a distal joint portion 62 including a substantially uniform cylindrical outer surface 64 free from threads and defining an outer diameter, a substantially uniform cylindrical inner surface 66 free from threads and a circumferential end 68 connecting the outer 64 and inner 66 surfaces. The connector 48 has two distal joint portions 72, 74. Distal joint portion 72 includes an outer surface 76 free from threads, an inner surface 78 free from threads and a circumferential end 80. Distal joint portion 74 includes an outer surface 84 free from threads, an inner surface 86 free from threads and a circumferential end 88. The connector 48 is short, for example with a typical length less than five to ten times its diameter.

The inner diameter of distal joint portion 72 is larger than the outer diameter of distal joint portion 52 to allow distal joint portion 52 of member 46 to be disposed within distal joint portion 72 of member 48. Since the members 46, 48, 50 are generally formed without machining, e.g. from purchased tubing or swaged tubing, each member can have a considerable range of distal joint portion diameters. Given this range of diameters the gap between a complementary set of members 46, 48 and 48, 50 can be in the range of about 0.001 inches to about 0.05 inches.

To prepare a high pressure connection complementary members 46, 48 are provided. The mating surfaces 54, 78 should be clean and free of contamination. Abrasion of one or both mating surfaces may be advantageous. A primer composition is applied to one mating surface 54 or 78 of one distal joint portion 46, 48 respectively. A curable composition is applied to the mating surface of the other of the distal joint portion. The smaller diameter distal joint portion 52 is slidingly disposed within the larger diameter distal joint portion 72. Some rotation of the distal joint portions may be beneficial to distribute the primer composition and curable composition around the entirety of the mating surfaces but is not required. The members 46, 48 are held in position for less than about 30 seconds, advantageously less than about 15 seconds and desirably less than about 15 seconds to allow the curable composition to maintain the second tubular member distal joint portion within the first tubular member distal joint portion. The composition is cured for a short time thereby forming the high pressure connection between the ends 58, 80 of the distal joint portions 52, 72. Typical cure times will be less than 60 minutes and advantageously less than 30 minutes before the connection can be pressurized for use. The high pressure connection will maintain pressure greater than about 1200 pounds per square inch and advantageously greater than about 1500 pounds per square inch and more advantageously greater than about 2000 pounds per square inch after fully curing. Distal joint portions 62 and 74 are processed in the same manner to form a second high pressure connection between the ends 88, 68 of distal joint portions 74, 62. Plastic deformation in the material of any distal joint portion 52, 62, 72, 74 after disposition of the smaller diameter distal joint portions 52, 62 within the larger diameter distal joint portions 72, 74 is advantageously avoided. The connector may be straight as shown in FIG. 3 or otherwise shaped such as a “U” shaped return bend useful to fluidly connect condenser tubes.

The connector distal portions may have a smaller diameter than the corresponding tubular member distal portions so that the connector distal portions are disposed within the tubular member distal portions. Similarly, while the method is described with reference to the tubular connectors most often used, connectors of other shapes having the necessary complementary shape are possible.

In some applications it may be desirable to apply one or both of the primer composition and curable composition to the distal joint portions after their assembly. For example, refrigeration capillary tubes have distal joint portions defining a very small diameter. Applying a non-flowable primer composition to one distal joint portion and a non-flowable curable composition to the other distal joint portion prior to assembly may increase the possibility that one or both of the compositions is introduced into the connection interior during assembly. To lessen this possibility either or both of the primer composition and curable composition can be applied to the distal joint portions after the second distal joint portion is slidingly received into the first distal joint portion. Thus a primer composition can be applied to one distal joint portion, the distal joint portions can be assembled and the curable composition can be applied to the assembled distal joint portions. Alternatively, a curable composition can be applied to one distal joint portion, the distal joint portions can be assembled and the primer composition can be applied to the assembled distal joint portions. As another alternative the distal joint portions can be assembled with no primer composition or curable composition and the curable composition and primer composition can be applied, sequentially or concurrently, to the assembled distal joint portions. In concurrent application it may be advantageous to apply the primer composition and curable composition to different portions of the assembly. These variations are advantageously useful with lower viscosity compositions that can wick or flow between the adjacent distal joint portions in the assembly.

It may also be useful to prepare a connection comprising multiple, male distal joint portions in a single female distal joint portion using the above methods.

The radically curable composition may be an anaerobically curable one, in which case the composition comprises a functional (meth)acrylate monomer and a cure-inducing component. The radically curable composition may optionally include a polymer matrix as discussed below. The cure-inducing component uses a free radical cure mechanism and advantageously uses an anaerobic cure mechanism.

The (meth)acrylate component will form the basis of the radically curable composition. That is, the curable composition may be comprised of greater than about 60% by weight of (meth)acrylate, such as about greater than about 65% by weight, desirably within the range of about 70% to about 75% by weight. If both mono and polyfunctional (meth)acrylate are present in the curable composition the monofunctional (meth)acrylate is advantageously present in an amount in the range of about 1% to about 30% by weight of the total composition and more advantageously in the range of about 10% to about 25% by weight of the total composition.

At least a portion of the (meth)acrylate monomer can be a mono-functional (meth)acrylate monomer. Thus, the (meth)acrylates that may be used in the curable composition include a wide variety of materials represented by H₂C═C(G)C(O)OR, where G may be hydrogen, halogen or alkyl of 1 to about 4 carbon atoms, and R may be selected from alkyl, cycloalkyl, alkenyl, cycloalkenyl, alkaryl, aralkyl, heterocyclic, hydroxyalkyl, or aryl groups of 1 to about 16 carbon atoms.

Other desirable polymerizable monomers useful in the curable composition include those which fall within the structure:

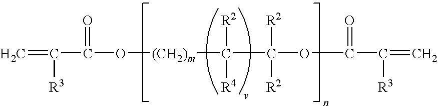

where R² may be selected from hydrogen, alkyl of 1 to about 4 carbon atoms, hydroxyalkyl of 1 to about 4 carbon atoms or

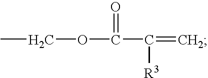

R³ may be selected from hydrogen, halogen, and alkyl of 1 to about 4 carbon atoms and C₁₋₈ mono- or bicycloalkyl, a 3 to 8 membered heterocyclic radical with a maximum of 2 oxygen atoms in the ring;
R⁴ may be selected from hydrogen, hydroxy and

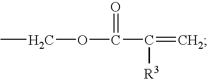

m is an integer equal to at least 1, e.g., from 1 to about 8 or higher, for instance from 1 to about 4;
n is an integer equal to at least 1, e.g., 1 to about 20 or more; and
v is 0 or 1.

Other desirable acrylate ester monomers are those selected from urethane acrylates within the general structure:

(CH₂═CR⁵.CO.O.R⁶.O.CO.NH)₂R⁷

where R⁵ is H, CH₃, C₂H₅ or halogen, such as Cl; R⁶ is (i) a C₁₋₈ hydroxyalkylene or aminoalkylene group, (ii) a C₁₋₁₆ alklamino-C₁₋₈ alkylene, a hydroxyphenylene, aminophenylene, hydroxynaphthalene or amino-naphthalene optionally substituted by a C₁₋₃ alkyl, C₁₋₃ alkylamino or di-C₁₋₃ alkylamino group; and R⁷ is C₂₋₂₀ alkylene, alkenylene or cycloalkylene, C₆₋₄₀ arylene, alkarylene, aralkarylene, alkyloxyalkylene or aryloxyarylene optionally substituted by 1-4 halogen atoms or by 1-3 amino or mono- or di-C₁₋₃ alkylamino or C₁₋₃ alkoxy groups; or acrylates within the general structure:

(CH₂═CR⁵.CO.O.R⁶.O.CO.NH.R⁷.NH.CO.X—)ₙR⁸

where R⁵, R⁶, and R⁷ are as given above, R⁸ is a non-functional residue of a polyamine or a polhydric alcohol having at least n primary or secondary amino or hydroxy groups respectively; X is O or NR⁹, where R⁹ is H or a C₁₋₇ alkyl group; and n is an integer from 2 to 20.

Among the specific monofunctional polymerizable acrylate ester monomers particularly desirable, and which correspond to certain of the structures above, are hydroxypropyl methacrylate, 2-hydroxyethyl methacrylate, methyl methacrylate, tetrahydrofurfuryl methacrylate, cyclohexyl methacrylate, 2-aminopropyl methacrylate and the corresponding acrylates.

Specific polyfunctional monomers which are desirable include polyethylene glycol dimethacrylate and dipropylene glycol dimethacrylate.

Other desirable polymerizable acrylate ester monomers useful in the instant disclosure are selected from the class consisting of the acrylate, methacrylate and glycidyl methacrylate esters of bisphenol A. Particularly desirable among all of the free-radical polymerizable monomers mentioned are ethoxylated bisphenol-A-dimethacrylate (“EBIPMA”).

Mixtures or copolymers of any of the above-mentioned free-radical polymerizable monomers can be employed.

Polymerizable vinyl monomers may also be optionally incorporated and are represented by the general structure:

R¹⁰—CH═CH—R¹⁰

where R¹⁰ is alkyl, aryl, alkaryl, aralkyl, alkoxy, alkylene, aryloxy, aryloxyalky, alkoxyaryl, aralkylene, OOC—R¹, where R¹ is defined above, can also be effectively employed in the instant composition.

Copolymers or mixtures of monomers disclosed herein with other compatible monomers are also contemplated.

Among the polymerizable polyacrylate esters utilized in accordance with the present disclosure include those which are exemplified but not restricted to the following materials: di-, tri-, and tetra-ethylene glycol dimethacrylate, dipropylene glycol dimethacrylate, polyethylene glycol dimethacrylate, di(pentamethylene glycol) dimethacrylate, tetraethylene glycol diacrylate, tetraethylene glycol di(chloroacrylate), diglycerol diacrylate, diglycerol tetramethacrylate, tetramethylene dimethacrylate, ethylene dimethacrylate, neopentyl glycol diacrylate and trimethylol propane triacrylate. The foregoing monomers need not be in the pure state, but may comprise commercial grades in which inhibitors or stabilizers, such as polyhydric phenols, quinones, and the like are included. These materials function as free radical inhibitors to prevent premature polymerization. It is also within the scope of this disclosure to obtain modified characteristics for the cured composition by utilization of one or more monomers either from those listed above or additional additives such as unsaturated monomers, including unsaturated hydrocarbons and unsaturated esters.

Some specific (meth)acrylates particularly useful in the curable composition include polyethylene glycol di(meth)acrylates, bisphenol-A di(meth)acrylates, such as ethoxylated bisphenol-A (meth)acrylate (“EBIPMA”) and tetrahydrofurane (meth)acrylates and di(meth)acrylates, isobornyl acrylate, hydroxypropyl (meth)acrylate, and hexanediol di(meth)acrylate. Of course, combinations of these (meth)acrylates may also be used.

The curable composition is rendered curable by including a cure-inducing component that uses a free radical cure mechanism and advantageously uses an anaerobic cure mechanism.

The radical cure-inducing component can also be a heat-cure initiator or initiator system comprising a redox polymerization initiator (i.e., an ingredient or a combination of ingredients which at the desired elevated temperature conditions, e.g., from about 90° C. to about 150° C. (about 194° F. to about 302° F.) produces an oxidation-reduction reaction, resulting in the production of free radicals). Suitable initiators may include peroxy materials, e.g., peroxides, hydroperoxides, and peresters, which under appropriate elevated temperature conditions decompose to form peroxy free radicals which are initiatingly effective for the polymerization of the heat-curable compositions. The peroxy materials may be employed in the radical cure-inducing component in concentrations on the order of about 0.1% to about 10%.

Another useful class of heat-curing initiators comprises azonitrile compounds which yield free radicals when decomposed by heat. Heat is applied to the curable composition and the resulting free radicals initiate polymerization of the curable composition.

For example, azonitrile may be a compound of the formula:

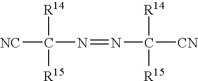

where R¹⁴ is a methyl, ethyl, n-propyl, iso-propyl, iso-butyl or n-pentyl radical, and R¹⁵ is a methyl, ethyl, n-propyl, iso-propyl, cyclopropyl, carboxy-n-propyl, iso-butyl, cyclobutyl, n-pentyl, neo-pentyl, cyclopentyl, cyclohexyl, phenyl, benzyl, p-chlorobenzyl, or p-nitrobenzyl radical or R¹⁴ and R¹⁵ taken together with the carbon atom to which they are attached, represent a radical of the formula

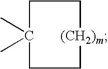

where m is an integer from 3 to 9, or the radical, or

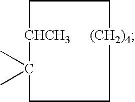

Compounds of the above formula are more fully described in U.S. Pat. No. 4,416,921, the disclosure of which is incorporated herein by reference.

Azonitrile initiators of the above-described formula are readily commercially available, e.g., the initiators which are commercially available under the trademark VAZO from E. I. DuPont de Nemours and Company, Inc., Wilmington, Del., including VAZO 52 (R¹⁴ is methyl, R¹⁵ is isobutyl), VAZO 64 (R¹⁴ is methyl, R¹⁵ is methyl), and VAZO 67 (R¹⁴ is methyl, R¹⁵ is ethyl), all such R¹⁴ and R¹⁵ constituents being identified with reference to the above-described azonitrile general formula. A desirable azonitrile initiator is 2,2′-azobis(iso-butyronitrile) or AZBN.

The azonitrile may be employed in the cure-inducing component in concentrations on the order of about 500 to about 10,000 parts per million (ppm) by weight, desirably about 1,000 to about 5,000 ppm.

The cure-inducing component can be an anaerobic cure-inducing component. Curing of the curable composition begins in the absence of air.

Examples of anaerobic cure-inducing components include amines (including amine oxides, sulfonamides and triazines). Other cure-inducing components include saccharin, toluidenes, such as N,N-diethyl-p-toluidene and N,N-dimethyl-o-toluidene, acetyl phenylhydrazine, and maleic acid. Of course, other materials known to induce anaerobic cure may also be included or substituted therefore. See e.g. U.S. Pat. Nos. 3,218,305 (Krieble), 4,180,640 (Melody), 4,287,330 (Rich) and 4,321,349 (Rich). Quinones, such as napthoquinone and anthraquinone, may also be included to scavenge free radicals.

The anaerobic cure-inducing component should be used in an amount up to about 10% by weight of the total curable composition, such as in the range of about 6% to about 8% by weight of the total curable composition.

The curable composition may optionally include a fluorescent dye to allow the user to determine composition presence and location on the high pressure connection.

The curable composition in the uncured state can have a range of viscosities, for example about 200 cps to about 4,000 cps, depending on application. Lower viscosities are useful in applications where a more fluid composition is desired while higher viscosities are useful in applications where less flow is desired. In addition, the composition in the cured state should be flexible/tough so as to absorb vibration that is present in a refrigeration system. The composition must also have good adhesive properties to maintain connection integrity under internal pressures more then 1200 pounds per square inch.

In one embodiment, the curable composition includes a polymerizable (meth)acrylate monomer, a polymerization initiator for the monomer, and optionally, a polymeric matrix miscible or otherwise compatible with the monomer. The matrix material may be present in an amount sufficient to render the curable composition non-flowable at temperatures of at least about 70° F. (21° C.), and up to about 160° F. (71° C.). The polymeric matrix and polymerizable component readily form a stable mixture or combination without phase separation of component parts.

In another embodiment the curable composition includes a self-supporting combination of a polymerizable (meth)acrylate monomer; a polymerization initiator; and optionally, a polymeric matrix miscible with the (meth)acrylate and the initiator. The polymeric matrix, if present, is included in an amount sufficient to render the curable composition non-flowable at temperatures of up to 160° F. (71° C.).

The primer composition includes an activator. In some embodiments the primer composition includes, a reactive carrier, a polymeric matrix, or a reactive carrier and a polymeric matrix. The polymeric matrix is selected from urea-urethanes, hydroxy or amine modified aliphatic hydrocarbons (such as castor oil-based rheological additives), liquid polyester-amide-based rheological additives, polyacrylamides, polyimides, polyhydroxyalkylacrylates, and combinations thereof.

The activator may differ depending on the nature and identity of the curable composition. In the case of anaerobically curable compositions the activator can comprise transition metal containing compounds, peroxy compounds, free radical promoters and the like as desired for the chosen anaerobically curable composition.

Useful activators comprising a transition metal-containing compound include those containing copper. The transition metal-containing compound may be selected from a list of materials, including among others copper-containing compounds or complexes, such as copper naphthenate, copper carbonate and cupric acetylacetone. Other desirable transition metal-containing compounds or complexes include those having iron or cobalt.

Useful activators comprising peroxy compounds include the hydroperoxy polymerization initiators and most preferably the organic hydroperoxide initiators having the formula ROOH, where R generally is a hydrocarbon radical containing up to about 18 carbons, desirably an alkyl, aryl or aralkyl radical containing up to about 12 carbon atoms. Typical examples of such hydroperoxides include cumene hydroperoxide, methylethylketone hydroperoxide as well as hydroperoxides formed by the oxygenation of various other hydrocarbons such as methylbutene, cetane and cyclohexane. Other peroxy initiators such as hydrogen peroxide or materials such as organic peroxides or peresters which hydrolyze or decompose to form hydroperoxides may also be employed.

The peroxy compounds commonly employed comprise less than about 20% by weight of the total primer composition. Desirably, however, they are employed in lower levels such as about 0.1% to about 10% by weight of the total primer composition.

Useful activators comprising free radical promoters include the heat-cure initiator or initiator systems comprising a redox polymerization initiator discussed above.

It is advantageous that the carrier used in the primer composition is reactive i.e. the carrier will participate in the curing reaction of the curable composition. Useful reactive carriers include (meth)acrylate monomers and mixtures, advantageously mono-functional (meth)acrylate monomers and mixtures, for example hydroxyethyl (meth)acrylate and hydroxypropyl (meth)acrylate. The carrier can comprise about 50% or more of the total weight of the primer composition.

Known primer compositions are typically formulated to have a low viscosity. A low viscosity is generally considered advantageous for many applications as it lets these materials flow into small gaps or openings by capillary action. However, low viscosity materials are less desirable in applications such as two part, high pressure connections wherein the mating members may have large gaps. For two part, high pressure connections the primer compositions is advantageously non-flowable, i.e., capable of existing in a self-supporting mass without migrating at temperatures of up to 160° F. (71° C.). Use of a non-flowable primer in connection with a curable composition is surprisingly effective in bridging the gap between complementary refrigeration members to help provide a high pressure connection that can withstand more than 1200 pounds per square inch of internal pressure. Desirably the primer composition will be non-flowable at temperatures at working temperatures, for example temperatures in the range of about 60° F. (21° C.) to about 160° F. (71° C.).

Primer composition rheology properties, i.e., primer composition flowability, can be modified by adding polymeric matrix materials. The amount of polymeric matrix in the primer composition will vary from about 0% to about 30% or more. If flowability of the primer is desired the primer can comprise none or very little polymeric matrix. Addition of a diluent or solvent can also enhance primer composition flowability. As the amount of polymeric matrix in the primer composition is increased it becomes less flowable. The amount of polymeric matrix is only limited on the upper end by the strength and stiffness required in the final product. Of course, this is be balanced with the desired strength of the adhesive or the particular sealing characteristics desired. Addition of polymeric matrix in amounts of about 2.5% to about 20%, for instance about 5% to about 15%, such as about 7% to about 10%, by weight of the total composition can provide a primer composition having non-flowability characteristics with minimal undesirable effects, such as loss of substantial tensile properties or sealing characteristics.

The polymeric matrix includes an organic material which generally has a melting point or softening point range in the range of about 200° F. (93° C.) to about 500° F. (260° C.), more desirably greater than 250° F. (121° C.) to about 500° F. (260° C.). Polymeric materials may be selected from urea-urethanes, hydroxy or amine modified aliphatic hydrocarbons (such as castor oil-based rheological additives), liquid polyester-amide-based rheological additives and combinations thereof. In addition, the polymeric matrix may further include polyamides, polyacrylamides, polyimides, and polyhydroxyalkylacrylates.

Of particular utility are polyamide materials having a melting point of about 260° F. (127° C.). One such polyamide is commercially available as a non-reactive free flowing powder under the tradename DISPARLON 6200, from King Industries Specialties Company, Norwalk, Conn. Other polyamides include DISPARLON 6100 and 6500. The recommended use in accordance with commercially available data sheets for DISPARLON 6200 is for epoxy adhesive and potting compounds in amounts of about 0.5% to about 3% by weight; the recommended use in accordance with commercially available data sheets for DISPARLON 6500 is for epoxy adhesive and potting compounds in amounts of about 0.5% to about 3% by weight.

The polyamide materials of the primer composition desirably have a particle size less than about 15 microns, although other particle sizes are useful. As previously mentioned, the melting or softening point of the polymeric matrix materials ranges from about 200° F. (93° C.) to about 500° F. (260° C.). In a particularly desirable embodiment, a polyamide having a melting point of about 250° F.-270° F. (121° C.-132° C.) and more desirably about 260° F. (127° C.) is employed.

A more particular description of a urea-urethane includes a combination of an alkali metal cation and the reaction product of (a) a polyfunctional isocyanate and an hydroxy and an amine; or (b) a phosgene or phosgene derivative, and a compound having 3 to 7 polyethylene ether units terminated at one end with an ether group and at the other end with a reactive functional group selected from an amine, an amide, a thiol or an alcohol; or (c) a monohydroxy compound, a diisocyanate and a polyamine. When the reaction product described in (c) is employed it is generally formed by first reacting a monohydroxy compound with a diisocyanate to form a mono-isocyanate adduct, and subsequently reacting the mono-isocyanate reaction product with a polyamine in the presence of an alkali metal salt and an aprotic solvent, as described in U.S. Pat. No. 4,314,924, the disclosure of which is incorporated herein by reference. A commercially available version of the reaction product described in (c) is believed to be BYK-410, from BYK-Chemie, Wallingford, Conn. BYK-Chemie describes this reaction product as a urea-urethane.

Useful isocyanates for forming the reaction product(s) of the additive include polyisocyanates such as phenyl diisocyanate, toluene diisocyanate, 4,4′-diphenyl diisocyanate, 4,4′-diphenylene methane diisocyanate, dianisidine diisocyanate, 1,5-naphthalene diisocyanate, 4,4′-diphenyl ether diisocyanate, p-phenylene diisocyanate, 4,4′-dicyclo-hexylmethane diisocyanate, 1,3-bis-(isocyanatomethyl)cyclohexane, cyclohexylene diisocyanate, tetrachlorophenylene diisocyanate, 2,6-diethyl-p-phenylenediisocyanate, and 3,5-diethyl-4,4′-diisocyanatodiphenylmethane. Still other polyisocyanates that may be used are polyisocyanates obtained by reacting polyamines containing terminal, primary and secondary amine groups or polyhydric alcohols, for example, the alkane, cycloalkane, alkene and cycloalkane polyols such as glycerol, ethylene glycol, bisphenol-A, 4,4′-dihydroxy-phenyldimethylmethane-substituted bisphenol-A, and the like, with an excess of any of the above-described isocyanates.

Useful alcohols for reacting with the polyisocyanates also include polyethyl glycol ethers having 3-7 ethylene oxide repeating units and one end terminated with an ether or an ester, polyether alcohols, polyester alcohols, as well as alcohols based on polybutadiene. The specific type of alcohol chosen and the molecular weight range can be varied to achieve the desired effect. Generally, monohydroxy compounds, straight or branched chain aliphatic or cyclic primary or secondary alcohols containing C₅₋₂₅, and alkoxylated derivatives of these monohydroxy compounds are useful.

Phosgene and phosgene derivatives, such as bischloroformates, may be used to make the reaction product of the additive (c). These compounds are reacted with a nitrogen-containing compound, such as an amine, an amide or a thiol to form the adduct. Phosgenes and phosgene derivatives may also be reacted with an alcohol to form the reaction product.

The alkali metal cations are usually provided in the form of a halide salt. For example, sodium, potassium and lithium halide salts are useful. In particular, sodium chloride, sodium iodide, sodium bromide, potassium chloride, potassium iodide, potassium bromide, lithium chloride, lithium iodide, lithium bromide and combinations thereof may be employed.

The reaction products of additive (c) are usually present in and added to the composition with an alkali metal salt, in a solvent carrier. The solvents are desirably polar aprotic solvents in which the reaction to form the reaction product was carried out. For example, N-methylpyrrolidone, dimethylsulfoxide, hexamethylphosphoric acid triamide, N,N-dimethylformamide, N,N,N′,N′-tetramethylurea, N,N-dimethylacetamide, N-butylpyrrolidone, tetrahydrofuran and diethylether may be employed.

One particularly desirable additive is the combination of a lithium salt and a reaction product which is formed by reacting a monohydroxy compound with a diisocyanate compound to form a mono-isocyanate first adduct, which is subsequently reacted with a polyamine in the presence of lithium chloride and 1-methyl-2-pyrrolidone to form a second adduct. A commercially available additive of this sort is sold by BYK Chemie, Wallingford, Conn. under the tradename BYK 410. This commercially available additive is described by BYK-Chemie product literature as being a urea urethane having a minor amount of lithium chloride present in a 1-methyl-2 pyrrolidone solvent.

Amines which can be reacted with phosgene or phosgene derivatives to make the reaction product include those which conform to the general formula R¹¹—NH₂, where R¹¹ is aliphatic or aromatic. Desirable aliphatic amines include polyethylene glycol ether amines. Desirable aromatic amines include those having polyethylene glycol ether substitution on the aromatic ring.

For example, commercially available amines sold under the tradename JEFFAMINE by Huntsman Corporation, Houston, Tex. may be employed. Examples include JEFFAMINE D-230, JEFFAMINE D-400, JEFFAMINE D-2000, JEFFAMINE T-403, JEFFAMINE ED-600, JEFFAMINE ED-900, JEFFAMINE ED-2001, JEFFAMINE EDR-148, JEFFAMINE XTJ-509, JEFFAMINE T-3000, JEFFAMINE T-5000, and combinations thereof.

The JEFFAMINE D series are diamine based products and may be represented by:

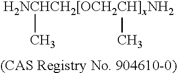

where x is about 2.6 (for JEFFAMINE D-230), 5.6 (for JEFFAMINE D-400) and 33.1 (for JEFFAMINE D-2000), respectively.

The JEFFAMINE T series are trifunctional amine products based on propylene oxide and may be represented by:

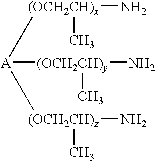

where x, y and z are set forth below in Table 1.

TABLE 1

| | | |
|---|---|---|
| JEFFAMINE | Approx. | Mole |

| Product | Initiator (A) | Mol. Wt. | % |
|---|---|---|---|
| T-403 | Trimethylolpropane | 440 | 5-6 |
| T-3000 | Glycerin | 3,000 | 50 |
| T-5000 | Glycerin | 5,000 | 85 |

More specifically, the JEFFAMINE T-403 product is a trifunctional amine and may be represented by:

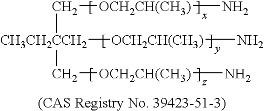

where x+y+z is 5.3.

The JEFFAMINE ED series are polyether diamine-based products and may be represented by:

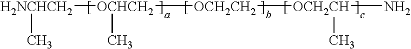

where a, b and c are set forth below in Table 2.

TABLE 2

| | | |
|---|---|---|
| JEFFAMINE | Approx. Value | Approx. |

| Product | b | a + c | Mol. Wt. |
|---|---|---|---|
| ED-600 | 8.5 | 2.5 | 600 |
| ED-900 | 15.5 | 2.5 | 900 |
| ED-2001 | 40.5 | 2.5 | 2,000 |

Amides useful for reacting with the phosgene or phosgene derivatives include those which correspond to the following formula:

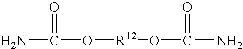

where R¹² may be an aliphatic or aromatic, substituted or unsubstituted, hydrocarbon or heterohydrocarbon, substituted or unsubstituted, having C₁₋₃₆.

Alcohols useful in forming the reaction product with the phosgene or phosgene derivatives include those described above.

Another polymeric matrix useful herein includes hydroxyl or amine modified aliphatic hydrocarbons and liquid polyester-amide based rheological additives. Hydroxy or amine modified aliphatic hydrocarbons include THIXCIN R, THIXCIN GR, THIXATROL ST and THIXATROL GST available from Rheox Inc., Hightstown, N.J. These modified aliphatic hydrocarbons are castor oil based materials. The hydroxyl modified aliphatic hydrocarbons are partially dehydrated castor oil or partially dehydrated glycerides of 12-hydrostearic acid. These hydrocarbons may be further modified with polyamides to form polyamides of hydroxyl stearic acid are described as being useful polyamides.

Liquid polyester-amide based rheological additives include THIXATROL TSR, THIXATROL SR and THIXATROL VF rheological additives available from Rheox Inc., Hightstown, N.J. These rheological additives are described to be reaction products polycarboxylic acids, polyamines, alkoxylated polyols and capping agents. Useful polycarboxylic acids include sebacic acid, poly(butadiene) dioic acids, dodecane dicarboxylic acid and the like. Suitable polyamines include diamine alkyls. Capping agents are described as being monocarboxylic acids having aliphatic unsaturation.

Other agents common to the art, for example thickeners plasticizers, pigments, dyes, diluents, solvents and fillers, and can be employed in any reasonable manner to produce desired functional characteristics, providing they do not significantly interfere with the ability of the primer composition to initiate polymerization of the curable composition or interfere with providing a high pressure connection. If present, inert fillers are used in relatively high amounts as compared to conventional threadlocking systems.

Preparation of the Primer Compositions can be Achieved by Simple Admixture of the preselected materials. If present, no premelting of the polymeric matrix is necessary and the polymeric matrix can be in either the liquid or solid form prior to incorporation thereof. Although it is not necessary to heat the primer composition prior to incorporation of the polymeric matrix, as a practical matter it is desired to slightly elevate the temperature to within the range of about 40-60° C., such as about 50° C. (122° F.), while using a mixer or dispenser machine to incorporate the polymeric matrix. Mixing is performed for a time sufficient to incorporate the matrix material into the primer composition, which can vary depending on the batch size. Generally, only seconds or minutes are required to achieve the desired blending in of the matrix material. The composition will render itself non-flowable in approximately 2 to about 100 hours at room temperature depending on the nature and relative amounts the primer composition components. This is due to the unique nature of the polymeric matrix, which is designed to be swellable and effectively form a branched matrix in situ. While not wishing to be bound by any particular hypothesis, it is believed that the polymeric matrix particles retain their particulate nature, yet imbibe large amounts of the primer composition materials. In doing so, they lend the non-flowable characteristics to the primer composition, yet apply smoothly to a surface by virtue of its particulate nature. It appears that a portion of the matrix particle is solubilized which permits the imbibing, and a portion remains unsolubilized which allows for retention of its particulate form.

The following examples are included for purposes of illustration so that the disclosure may be more readily understood and are in no way intended to limit the scope of the disclosure unless otherwise specifically indicated.

### EXAMPLES

### Example 1

With reference to FIG. 4, two tubular members were provided. One member was a straight aluminum tube with a closed end and an open end having an expanded diameter. The second member was an “L” shaped copper tube with a closed end, fittings for pressurization and gauge connection adjacent the closed end and an open end. The open end retained the same diameter as the body of the second member. The open end of the copper tube could be readily disposed within the open end of the aluminum tube without interference between the ends. The open end of the copper tube would readily slide out of the open end of the aluminum tube under its own weight.

A primer was applied to one member mating end. An anaerobically curable composition was applied to the mating end of the other member. The copper open end was slidingly disposed into the aluminum open end with some rotation between the parts to help distribute the primer and curable composition. The parts were held together for less than 10 seconds. The composition was allowed to cure for one hour. The connection was subjected to an internal pressure of 360 pounds per square inch with no leakage or joint failure.

Aluminum and copper tubes of the same size and type as used above were obtained. The open end of the copper tube could be readily disposed within the open end of the aluminum tube without interference between the ends. The open end of the copper tube would readily slide out of the open end of the aluminum tube under its own weight.

The same anaerobically curable compositions as used above were applied to the mating surface of one member. No primer was used. The copper open end was slidingly disposed into the aluminum open end with some rotation between the parts to help distribute the primer and curable composition. The parts were held together for less than 10 seconds. The composition was allowed to cure for one hour. The connection could not hold an internal pressure of more than 360 pounds per square inch. Results are summarized in the following Table.

TABLE 3

| curable composition | primer composition | result |
|---|---|---|
| LOCTITE 640*¹ | none | fail - leakage |
| LOCTITE 661*² | none | fail - leakage |
| LOCTITE 290*³ | none | fail - leakage |
| LOCTITE 2760*⁴ | none | fail - leakage |
| LOCTITE 640 | 7088*⁵ | pass - no leakage |
| LOCTITE 2760 | 7088 | pass - no leakage |

*¹LOCTITE 640 is a liquid comprised of 30-60% polyurethane methacrylate resin; 10-30% polyglycol dimethacrylate; 5-10% hydroxyalkyl methacrylate; 5-10% acrylic acid; and 1-5% cumene hydroperoxide.
*²LOCTITE 661 is comprised of 30-60% polyurethane methacrylate resin; 10-30% polyglycol dimethacrylate; 5-10% acrylic acid; 5-10% hydroxyalkyl methacrylate; 1-5% polyglycol dimethacrylate; 1-5% photoinitiator; 1-5% cumene hydroperoxide and 0.1-1% 1-acetyl-2-phenylhydrazine.
*³LOCTITE 290 is a liquid comprised of 60-100% polyglycol dimethacrylate; 1-5% cumene hydroperoxide; and 1-5% saccharin.
*⁴LOCTITE 2760 is a liquid comprised of 60-100% dimethacrylate ester; 10-30% polyglycol dimethacrylate; 5-10% methacrylate ester; 1-5% treated fumed silica; 1-5% saccharin; and 0.1-1% 1-acetyl-2-phenylhydrazine.
*⁵LOCTITE 7088 is a self supporting gel comprised of 60-100% hydroxyalkyl methacrylate; 5-10% thixotropic agent; 1-5% methacrylic acid; and 1-5% 2-ethylhexanoic acid.

### Example 2

With reference to FIG. 4, two tubular members were provided. One member was a straight aluminum tube with a closed end and an open end having an expanded diameter. The second member was an “L” shaped copper tube with a closed end, fittings for pressurization and gauge connection adjacent the closed end and an open end. The open end retained the same diameter as the body of the second member. The open end of the copper tube could be readily disposed within the open end of the aluminum tube without interference between the ends. The open end of the copper tube would readily slide out of the open end of the aluminum tube under its own weight.

A primer was applied to one member mating end. Primer 7088 was applied as a gel from a tube while primer A was brushed on the mating end. An anaerobically curable composition was applied to the mating end of the other member. The copper open end was slidingly disposed into the aluminum open end with some rotation between the parts to help distribute the primer and curable composition. The parts were held together for less than 10 seconds. The composition was allowed to cure for 24 hours. The connection was subjected to an internal pressure of 2500 pounds per square inch with no leakage or joint failure. This connection was suitable for use in high pressure applications such as compressed gas systems and refrigeration systems.

Aluminum and copper tubes of the same size and type as used above were obtained. The open end of the copper tube could be readily disposed within the open end of the aluminum tube without interference between the ends. The open end of the copper tube would readily slide out of the open end of the aluminum tube under its own weight.

The same anaerobically curable compositions as used above were applied to the mating surface of one member. No primer was used. The copper open end was slidingly disposed into the aluminum open end with some rotation between the parts to help distribute the primer and curable composition. The parts were held together for less than 10 seconds. The composition was allowed to cure for 24 hours. The connection could not hold an internal pressure of more than 2500 pounds per square inch. This connection was not suitable for use in high pressure applications such as in compressed gas systems or refrigeration systems. Results are summarized in the following Table.

TABLE 4

| curable composition | primer composition | result |
|---|---|---|
| LOCTITE 640 | none | fail - leakage |
| LOCTITE 661 | none | fail - leakage |
| LOCTITE 290 | none | fail - leakage |
| LOCTITE 2760 | none | fail - leakage |
| LOCTITE 640 | 7088 | pass - no leakage |
| LOCTITE 290 | 7088 | pass - no leakage |
| LOCTITE 2760 | 7088 | pass - no leakage |
| LOCTITE 640 | A*¹ | pass - no leakage |
| LOCTITE 290 | A*¹ | pass - no leakage |
| LOCTITE 2760 | A*¹ | pass - no leakage |

*2 Primer A is of similar formulation to LOCTITE 7088 but with a viscosity of less than about 5,000 cps.

### Example 3

A first consumer refrigerator was purchased. The refrigerator was checked to ensure it operated properly. After the operation check the refrigerant was evacuated and all brazed connections were disassembled.

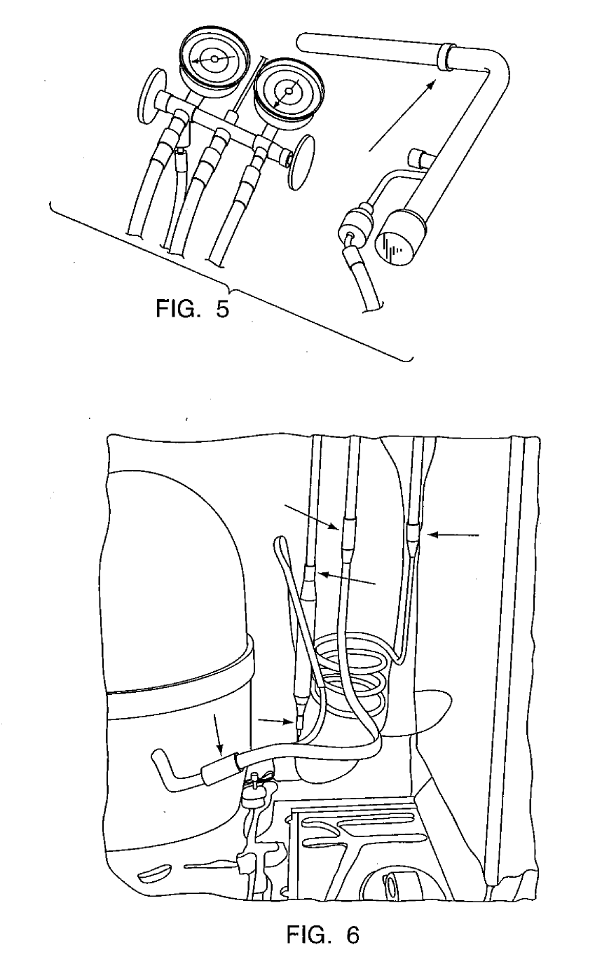

Each connection was reassembled by applying LOCTITE 7088 primer to one component and LOCTITE 640 as a curable composition to the other component. The components in each joint were slidingly disposed together. The parts were held together for less than 10 seconds. The composition was allowed to cure for less than about 1 hour. FIG. 5 illustrates the refrigerator after the connections were assembled using the curable composition. The refrigeration system was refilled with refrigerant and refrigeration oil as per the manufacturer's specifications and started within 1 hour of making the new connections. No leaks were found in any connection. The refrigerator was started and performed normally. The refrigerator has been in use for over four months with no loss of performance and no failure or leak at any connection.

A second consumer refrigerator as used above was purchased. The refrigerator was checked to ensure it operated properly. After the operation check the refrigerant was evacuated and all brazed connections were disassembled.

Each connection was reassembled by applying LOCTITE 640 as a curable composition to one component. The components in each joint were slidingly disposed together. The components in each joint were slidingly disposed together. The parts were held together for less than 10 seconds. The composition was allowed to cure for less than about 1 hour. The refrigeration system was refilled with refrigerant and refrigeration oil as per the manufacturer's specifications and started within 1 hour of making the new connections. Almost immediately refrigerant leaks were found in multiple connections. The refrigeration system was evacuated. The connections were not suitable for use in the refrigeration system.

1. A method of making a high pressure connection, the connection consisting essentially of a first tubular member, a second tubular member and a cured composition, comprising:
providing the first tubular member having a distal joint portion;
providing the second tubular member having a distal joint portion;
applying a primer composition to one of the distal joint portions;
applying a radically curable composition to the other of the distal joint portions;
sliding the second tubular member distal joint portion into the first tubular member distal joint portion, the first member outer surface defining an exterior surface of the high pressure connection and the second member inner surface defining an interior surface of the high pressure connection;
curing the curable composition to maintain the second tubular member distal joint portion within the first tubular member distal joint portion thereby forming the high pressure connection.

2. (canceled)

3. The method of claim 1 wherein one of the first or second tubular members is aluminum and the other of the members is selected from copper, aluminum, steel, coated steel and plastic.

4. The method of claim 1 wherein the primer composition comprises a transition metal-containing compound and a reactive carrier.

5. The method of claim 1 wherein the curable composition comprises up to about 65% by weight of a polyfunctional (meth)acrylate; 0% by weight to about 25% by weight of a monofunctional (meth)acrylate; and about 0.1% by weight to about 10% by weight of a cure-inducing component having a free radical cure mechanism.

6. (canceled)

7. A high pressure, connection, comprising:
a first tubular member having a first distal joint portion including a substantially cylindrical outer surface free from threads, a substantially cylindrical inner surface free from threads having an inner diameter defining a bore through the member, and a circumferential first end connecting the outer and inner surfaces;
a second tubular member having a second distal joint portion including a substantially uniform cylindrical outer surface free from threads and defining an outer diameter smaller than the first member inner diameter, a substantially uniform cylindrical inner surface free from threads defining a bore through the member, and a circumferential second end connecting the outer and inner surfaces, the second distal joint portion disposed within the first distal joint portion, wherein the outer diameter is substantially constant over the length of the second distal joint portion; and
a cured reaction product of an anaerobically curable composition disposed between the distal joint portions;
wherein one of the first tubular member or second tubular member is aluminum and the other is selected from aluminum, copper, brass, steel, coated steel and plastic.

8. (canceled)

9. A refrigeration system or gas compression system comprising the two part, high pressure, fluid impermeable connection of claim 7.

10. (canceled)

11. A method of making a high pressure connection, the connection consisting essentially of a first distal joint portion, a second distal joint portion and a cured composition disposed between the first and second distal joint portions, comprising:
providing the first distal joint portion including an outer surface free from threads, a substantially uniform cylindrical inner mating surface free from threads having an inner diameter defining a bore through the distal joint portion, and a circumferential end connecting the outer and inner surfaces;
providing the second distal joint portion including a substantially uniform cylindrical outer mating surface free from threads and defining an outer diameter smaller than the first distal joint portion inner diameter, a substantially uniform cylindrical inner surface free from threads defining a bore through the distal joint portion, and a circumferential end connecting the outer and inner surfaces;
applying a primer composition to one of the distal joint portion mating surfaces;
applying an anaerobically curable composition to the other of the distal joint portion mating surfaces;
sliding the second distal joint portion into the first distal joint portion;
curing the anaerobic composition to maintain the second distal joint portion within the first distal joint portion thereby forming the high pressure connection.

12. The method of claim 11 wherein the high pressure connection is a two part connection consisting essentially of the cured composition, a first tubular member including the first distal joint portion and a second tubular member including the second distal joint member.

13. The method of claim 11 wherein the high pressure connection is a multiple part connection consisting essentially of the cured composition, a connector including the first distal joint portion and a second tubular member including the second distal joint member.

14. The method of claim 11 wherein the first distal joint portion outer surface defines an exterior surface of the high pressure connection and the second distal joint portion inner surface defines an interior surface of the high pressure connection.

15. The method of claim 11 wherein:
the first distal portion extends from a first tubular member, the first tubular member having an unjoined length at least about ten times the first distal joint portion inner diameter; and
the second distal joint portion extends from a second tubular member, the second tubular member having an unjoined length at least about ten times the second distal joint portion outer diameter.

16. The method of claim 11 wherein the high pressure connection remains impermeable to a refrigerant at a pressure of 2000 pounds per square inch.

17. The method of claim 11 wherein one of the first or second distal joint portions is aluminum and the other of the distal joint portions is selected from copper, aluminum, steel, coated steel and plastic.

18. The method of claim 11 wherein the primer composition comprises about 0.1% by weight to about 20% by weight of a metal-containing compound; 0% by weight to about 30% by weight of a polymeric matrix selected from urea-urethanes, hydroxy or amine modified aliphatic hydrocarbons (such as castor oil-based rheological additives), liquid polyester-amide-based rheological additives, polyacrylamides, polyimides, polyhydroxyalkylacrylates, and combinations thereof; and about 50% by weight to about 99.9% by weight of a carrier comprising (meth)acrylate.

19. The method of claim 11 wherein the curable composition comprises a functional (meth)acrylate component, at least a portion of which includes a monofunctional (meth)acrylate; and a cure-inducing component having a free radical cure mechanism.

20. The method of claim 11 further comprising the step of avoiding plastic deformation of the first distal joint portion or second distal joint portion after the second distal joint portion is slid within the first distal joint portion.

21. A method of making a high pressure connection, the connection consisting essentially of a first tubular member, a second tubular member and a cured composition, comprising:
providing the first tubular member having a distal joint portion including a substantially uniform cylindrical outer surface free from threads, a substantially uniform cylindrical inner surface free from threads having an inner diameter defining a bore through the member, and a circumferential end connecting the outer and inner surfaces;
providing the second tubular member having a distal joint portion including a substantially uniform cylindrical outer surface free from threads and defining an outer diameter smaller than the first member inner diameter, a substantially uniform cylindrical inner surface free from threads defining a bore through the member, and a circumferential end connecting the outer and inner surfaces;
sliding the second tubular member distal joint portion into the first tubular member distal joint portion, the first member outer surface defining an exterior surface of the high pressure connection and the second member inner surface defining an interior surface of the high pressure connection;
providing a primer composition and a curable composition to the assembled distal joint portions; and
curing the curable composition to maintain the second tubular member distal joint portion within the first tubular member distal joint portion thereby forming the high pressure connection.

22. (canceled)

23. The method of claim 21 wherein one of the first or second tubular members is aluminum and the other of the member is selected from copper, aluminum, steel, coated steel and plastic.

24. (canceled)

25. The method of claim 21 wherein the curable composition comprises up to about 65% by weight of a polyfunctional (meth)acrylate; 0% by weight to about 25% by weight of a monofunctional (meth)acrylate; and about 0.1% by weight to about 10% by weight of a cure-inducing component having a free radical cure mechanism.

26. (canceled)

27. The method of claim 21 wherein the high pressure connection is a U shaped return bend.
